(19) United States
(12) Patent Application Publication
(10) Pub. No.: US 2024/0342791 A1
(43) Pub. Date: Oct. 17, 2024

(54) SYSTEMS AND METHODS FOR SYNTHESIS OF SPHEROIDIZED METAL POWDERS

(71) Applicant: 6K Inc., North Andover, MA (US)

(72) Inventors: Sunil Bhalchandra Badwe, Export, PA (US); Scott Joseph Turchetti, Newburyport, MA (US); Sudip Bhattacharya, Billerica, MA (US); Makhlouf Redjdal, Melrose, MA (US)

(21) Appl. No.: 18/513,326

(22) Filed: Nov. 17, 2023

Related U.S. Application Data
(62) Division of application No. 17/451,716, filed on Oct. 21, 2021, now Pat. No. 11,919,071.
(60) Provisional application No. 63/108,118, filed on Oct. 30, 2020.

(51) Int. Cl. B22F 1/065; B22F 1/05; B22F 9/14

(52) U.S. Cl. CPC B22F 1/065; B22F 1/05; B22F 9/14; B22F 2202/13; B22F 2302/20; B22F 2304/10

(57) ABSTRACT

Disclosed herein are embodiments of systems and method for processing feedstock materials using microwave plasma processing. Specifically, the feedstock materials disclosed herein pertain to metal powders. Microwave plasma processing can be used to spheroidize the metal powders and form metal nitride or metal carbide powders. The stoichiometry of the metal nitride or metal carbide powders can be controlled by changing the composition of the plasma gas and the residence time of the feedstock materials during plasma processing.

### INCORPORATION BY REFERENCE TO ANY PRIORITY APPLICATIONS

This application is a divisional of U.S. patent application Ser. No. 17/451,716, filed Oct. 21, 2021, which claims the priority benefit under 35 U.S.C. § 119(e) of U.S. Provisional Application No. 63/108,118, filed Oct. 30, 2020, the entire disclosure of which is incorporated herein by reference. Any and all applications for which a foreign or domestic priority claim is identified in the Application Data Sheet as filed with the present application are hereby incorporated by reference under 37 CFR 1.57.

### BACKGROUND

### Field

Some embodiments of the present disclosure are directed to systems and methods for producing metal spherical or spheroidal powder products from feedstock materials.

### Description

An important aspect of preparing some forms of industrial powders is the spheroidization process, which transforms irregularly shaped or angular powders produced by conventional crushing methods, into spherical low-porosity particles. Spherical powders are homogenous in shape, denser, less porous, have a high and consistent flowability, and high tap density. Such powders exhibit superior properties in applications such as injection molding, thermal spray coatings, and additive manufacturing, among others.

Creating spheroidal metallic powders, especially metallic powders containing materials such as titanium (Ti), can pose a number of challenges. Achieving the desired spheroidal shape, the desired level of porosity (e.g., no porosity to very porous), and the desired composition and microstructure can be difficult.

Titanium nitride powders are of particular interest. Titanium nitride has been used in a variety of applications, including in medical implants as a protective wear resistant coating. Many current orthopedic implants made from, for example, CoCr or titanium alloys (e.g., Ti-64), have poor wear resistance and require a titanium nitride coating to prevent eventual failure of the implant in the body. Titanium nitride is a ceramic with excellent wear and corrosion resistance and is compatible with human body. The coating is typically applied to implants by Chemical Vapor Deposition (CVD), where vapors of Ti are reacted with Nitrogen gas to form titanium nitride coating. This process forms a very thin, coherent layer of titanium nitride.

With the advent of additive manufacturing (AM), however, the design of implants has also evolved. It is now possible to design implants with internal cavities that reduce the weight of the implant and also provide a location for tissue growth inside the implant. However, with intricate internal cavities, coating a layer of titanium nitride evenly on the surfaces inside the implant has become challenging.

Thus, novel systems and methods of producing metal-containing spherical powders for use in additive manufacturing and other applications are needed.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Some embodiments herein are directed to methods for manufacturing a spheroidized metal nitride powder, the method comprising: providing a metal powder as a feedstock to a microwave plasma torch; introducing the feedstock into a microwave plasma generated by the microwave plasma torch, the microwave plasma generated by subjecting a nitrogen-containing gas to microwaves from a microwave power source; and forming the spheroidized metal nitride powder, the spheroidized metal nitride powder formed by at least partially melting the feedstock and initiating a chemical reaction between the feedstock and the nitrogen-containing gas within the microwave plasma torch.

In some embodiments, the method further comprises selecting a desired porosity, composition, or microstructure of the spheroidized metal nitride powder, and wherein the spheroidized metal nitride powder comprises the desired porosity, composition, or microstructure. In some embodiments, the spheroidized metal nitride powder comprises a particle-size distribution between 15-106 microns. In some embodiments, the metal powder comprises titanium powder. In some embodiments, the titanium powder comprises commercially pure titanium (cpTi) powder. In some embodiments, the titanium powder comprises gas atomized titanium powder, hydride-dehydride (HDH) titanium powder, or hydrided titanium powder. In some embodiments, the nitrogen-containing gas comprises one or more of hydrogen, helium, neon, argon, krypton, or xenon. In some embodiments, the nitrogen-containing gas comprises nitrogen gas (N₂). In some embodiments, the spheroidized metal nitride powder comprises spheroidized titanium nitride powder. In some embodiments, the spheroidized titanium nitride powder comprises one or more of TiN, Ti₂N, or TiN₂ phases. In some embodiments, the stoichiometry of the spheroidized metal nitride powder is controlled by altering the molar concentration of nitrogen in the nitrogen-containing gas and/or a residence time of the feedstock in the microwave plasma. In some embodiments, the chemical reaction comprises: 2Ti+N₂→2TiN; or 4Ti+N₂→2Ti₂N. In some embodiments, the spheroidized metal nitride powder comprises one or more of oxygen, iron, and carbon.

Some embodiments herein are directed to methods of additive manufacturing, comprising using the spheroidized metal nitride powder synthesized using a method for manufacturing a spheroidized metal nitride powder, the method comprising: providing a metal powder as a feedstock to a microwave plasma torch; introducing the feedstock into a microwave plasma generated by the microwave plasma torch, the microwave plasma generated by subjecting a nitrogen-containing gas to microwaves from a microwave power source; and forming the spheroidized metal nitride powder, the spheroidized metal nitride powder formed by at least partially melting the feedstock and initiating a chemical reaction between the feedstock and the nitrogen-containing gas within the microwave plasma torch.

Some embodiments herein are directed to spheroidized metal nitride powders synthesized according to a method for manufacturing a spheroidized metal nitride powder, the method comprising: providing a metal powder as a feedstock to a microwave plasma torch; introducing the feedstock into a microwave plasma generated by the microwave plasma torch, the microwave plasma generated by subjecting a nitrogen-containing gas to microwaves from a microwave power source; and forming the spheroidized metal nitride powder, the spheroidized metal nitride powder formed by at least partially melting the feedstock and initiating a chemical reaction between the feedstock and the nitrogen-containing gas within the microwave plasma torch.

Some embodiments herein are directed to methods for manufacturing a spheroidized metal carbide powder, the method comprising: providing a metal powder as a feedstock to a microwave plasma torch; introducing the feedstock into a microwave plasma generated by the microwave plasma torch, the microwave plasma generated by subjecting a carbon-containing gas to microwaves from a microwave power source; and forming the spheroidized metal carbide powder, the spheroidized metal carbide powder formed by at least partially melting the feedstock and initiating a chemical reaction between the feedstock and carbon-containing gas within the microwave plasma torch, the spheroidized metal carbide powder comprising a particle-size between 15-106 microns.

In some embodiments, the metal powder comprises silicon, aluminum, titanium, tungsten, or powder. In some embodiments, the titanium powder comprises commercially pure titanium (cpTi) powder. In some embodiments, the titanium powder comprises gas atomized titanium powder, hydride-dehydride (HDH) titanium powder, or titanium hydride powder. In some embodiments, the carbon-containing gas comprises one or more of hydrogen, helium, neon, argon, krypton, or xenon. In some embodiments, the carbon-containing gas comprises hydrocarbon gas. In some embodiments, the stoichiometry of the spheroidized metal nitride powder is controlled by altering the amount of carbon in the carbon-containing gas or a residence time of the feedstock in the microwave plasma.

Some embodiments herein are directed to methods of additive manufacturing, comprising using the spheroidized metal carbide powder manufactured using the method for manufacturing a spheroidized metal carbide powder, the method comprising: providing a metal powder as a feedstock to a microwave plasma torch; introducing the feedstock into a microwave plasma generated by the microwave plasma torch, the microwave plasma generated by subjecting a carbon-containing gas to microwaves from a microwave power source; and forming the spheroidized metal carbide powder, the spheroidized metal carbide powder formed by at least partially melting the feedstock and initiating a chemical reaction between the feedstock and carbon-containing gas within the microwave plasma torch, the spheroidized metal carbide powder comprising a particle-size between 15-106 microns.

Some embodiments herein are directed to spheroidized metal carbide powders manufactured according to the methods for manufacturing a spheroidized metal carbide powder, the method comprising: providing a metal powder as a feedstock to a microwave plasma torch; introducing the feedstock into a microwave plasma generated by the microwave plasma torch, the microwave plasma generated by subjecting a carbon-containing gas to microwaves from a microwave power source; and forming the spheroidized metal carbide powder, the spheroidized metal carbide powder formed by at least partially melting the feedstock and initiating a chemical reaction between the feedstock and carbon-containing gas within the microwave plasma torch, the spheroidized metal carbide powder comprising a particle-size between 15-106 microns.

Some embodiments herein are directed to methods for manufacturing a spheroidized powder, the method comprising: providing a feedstock to a microwave plasma torch; introducing the feedstock into a microwave plasma generated by the microwave plasma torch, the microwave plasma generated by subjecting a reactive plasma gas to microwaves from a microwave power source; and forming the spheroidized powder, the spheroidized powder formed by at least partially melting the feedstock and initiating a chemical reaction between the feedstock and the reactive plasma gas within the microwave plasma torch. In some embodiments, the method further comprises selecting a desired porosity, composition, or microstructure of the spheroidized powder, and wherein the spheroidized powder comprises the desired porosity, composition, or microstructure. In some embodiments, the spheroidized powder comprises a particle-size distribution between 15-106 microns. In some embodiments, the feedstock comprises titanium powder. In some embodiments, the titanium powder comprises commercially pure titanium (cpTi) powder. In some embodiments, the titanium powder comprises gas atomized titanium powder, hydride-dehydride (HDH) titanium powder, or hydrided titanium powder. In some embodiments, the reactive plasma gas comprises nitrogen-containing gas, wherein the nitrogen-containing gas comprises one or more of hydrogen, helium, neon, argon, krypton, or xenon. In some embodiments, the reactive plasma gas comprises nitrogen gas (N₂). In some embodiments, the spheroidized powder comprises spheroidized titanium nitride powder. In some embodiments, the spheroidized titanium nitride powder comprises one or more of TiN, Ti₂N, or TiN₂ phases. In some embodiments, the chemical reaction comprises: 2Ti+N₂→2TiN; or 4Ti+N₂→2Ti₂N. Some embodiments herein are directed to a method of additive manufacturing, comprising using the spheroidized powder synthesized using the method for manufacturing a spheroidized powder.

Some embodiments herein are directed to spheroidized titanium nitride powders comprising: a plurality of titanium nitride particles exhibiting a substantially spherical shape, the plurality of titanium nitride particles comprising a particle-size distribution between 15-106 microns and the plurality of titanium nitride particles comprising at least one of the following phases: α-Ti, TiN, Ti2N, or TiN2.

In some embodiments, the spheroidized titanium nitride powder is synthesized by microwave plasma processing of a titanium feedstock. In some embodiments, the plurality of particles comprise a microstructure formed by reacting the titanium feedstock with a nitrogen-containing plasma gas. In some embodiments, the plurality of particles have a mean sphericity greater than 0.75 or 0.91. In some embodiments, the plurality of particles have a median sphericity greater than 0.75 or 0.91. In some embodiments, the plurality of particles comprise a titanium nitride shell formed with a cpTi core. In some embodiments, the plurality of particles comprise titanium nitride throughout the particles.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates an example flowchart of a process for producing a spheroidized metal-containing powder according to some embodiments described herein.

FIG. 2 illustrates an example diagram of a microwave plasma torch according to some embodiments described herein.

FIG. 3 illustrates an example morphology of titanium nitride powder produced according to some embodiments described herein.

FIG. 4 illustrates an example microstructure of titanium nitride powder produced according to some embodiments described herein.

FIG. 5 illustrates an example X-ray powder diffraction of a titanium powder produced according to some embodiments described herein.

FIG. 6 illustrates an example particle size distribution of a titanium powder produced according to some embodiments described herein.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

Disclosed herein are embodiments of methods and systems for manufacturing spheroidized powders. Some embodiments herein relate to production of metallic powders comprising metals, metal alloys, carbides, nitrides, or other materials which can be difficult to spheroidize. Achieving the desired spheroidal shape, the desired level of porosity (e.g., no porosity to very porous), and the desired composition and microstructure can be difficult. Some embodiments herein relate to the production of metal nitride or metal carbide powders. Titanium nitride is a ceramic with a melting temperature of about 2,930° C. When using plasma processing, the combination of the temperature achieved in a plasma and the residence time of a titanium nitride feedstock may not provide the heat flux needed for the titanium nitride to melt. Spheroidization is only possible if the particles passing through the plasma are fully melted, partially melted, or surface melted. Hence, spheroidization of a titanium nitride feedstock using plasma processing may be difficult. However, spheroidized powders may be useful in a variety of applications including additive manufacturing, such as laser bed systems, electron beam systems and binder jetting systems. For example, 3-dimensional printing of a medical implant using an AM-compatible titanium nitride powders would eliminate expensive, time consuming, and unnecessary processing (e.g., CVD) of the implants and reduce the lead time for manufacturing. Due to the wear resistance and corrosion resistance of the titanium nitride, no other coating may be needed.

In some embodiments, the basic material requirement for additive manufacturing is a metal alloy, metal carbide, or metal nitride powder in spherical form and within a specified particle size, usually in the micron range. One of the most critical attributes to control is the particle size of the powder, as this is a critical parameter in the AM process. Particle size distribution has a direct influence on powder flowability and the ability to provide a uniform, powder bed density. This in turn determines the energy input needed to process the powder grains and also affects the surface finish. For example, a spheroidized powder usable in AM process may have a particle size distribution between about 15-45 microns, about 20-63 microns, or about 45-106 microns. However, according to some of the methods and systems described herein, a spheroidized powder may comprise a particle size distribution in the nanometer range to the millimeter range, in addition to the micrometer ranges generally required for AM processes. For example, a spheroidized powder according to the embodiments herein may comprise a particle size distribution between about 0.1 microns to about 1000 microns. In some embodiments, a spheroidized powder according to the embodiments herein may comprise a particle size distribution between about 0.1 microns and about 1 micron, between about 1 micron and 15 microns, between about 15 microns and about 45 microns, between about 20 microns and 63 microns, between about 45 microns and about 106 microns, between about 106 microns and about 200 microns, between about 200 microns and 300 microns, between about 300 microns and about 400 microns, between about 400 microns and about 500 microns, between about 500 microns and about 600 microns, between about 600 microns and about 700 microns, between about 700 microns and about 800 microns, between about 800 microns and about 900 microns, and between about 900 microns and about 1000 microns, or between any of the aforementioned ranges.

Furthermore, to be useful in additive manufacturing or powder metallurgy (PM) applications that require high powder flow, metal powder particles should exhibit a spherical shape, which can be achieved through the process of plasma spheroidization. This process involves the full melting, surface melting or partial melting of particles in a hot environment whereby surface tension of the liquid metal shapes each particle into a spherical geometry, followed by cooling and re-solidification.

In some embodiments, the final particles achieved by the plasma processing can be spherical, spheroidized, or spheroidal, terms which can be used interchangeably. Advantageously, by using the critical and specific disclosure relevant to each of the different feedstocks disclosed, all of the feedstocks can be transformed into the spherical powders.

Embodiments of the present disclosure are directed to producing particles that are substantially spheroidized or have undergone significant spheroidization. In some embodiments, spherical, spheroidal or spheroidized particles refer to particles having a sphericity greater than a certain threshold. Particle sphericity can be calculated by calculating the surface area of a sphere A_{s,ideal} with a volume matching that of the particle, V using the following equation:

$${r}_{ideal} = \sqrt[2]{\frac{3 V}{4 π}}$$

$${A}_{s , ideal} = 4 π {r}_{ideal}^{2}$$

The idealized surface area can be compared with the measured surface area of the particle, A_{s,actual}:

$$sphericity = \frac{{A}_{s , ideal}}{{A}_{s , actual}} .$$

In some embodiments, particles can have a mean sphericity of greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, particles can have a sphericity of 0.75 or greater or 0.91 or greater (or about 0.75 or greater or about 0.91 or greater). In some embodiments, particles can have a sphericity of less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a particle is considered to be spherical, spheroidal or spheroidized if it has a sphericity at or above any of the aforementioned sphericity values, and in some preferred embodiments, a particle is considered to be spherical if its sphericity is at or about 0.75 or greater or at or about 0.91 or greater.

In some embodiments, a median sphericity of all particles within a given powder can be greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, a median sphericity of all particles within a given powder can be less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a powder is considered to be spheroidized if all or a threshold percentage (as described by any of the fractions below) of the particles measured for the given powder have a median sphericity greater than or equal to any of the aforementioned sphericity values, and in some preferred embodiments, a powder is considered to be spheroidized if all or a threshold percentage of the particles have a median sphericity at or about 0.75 or greater or at or about 0.91 or greater.

In some embodiments, the fraction of particles within a powder that can be above a given sphericity threshold, such as described above, can be greater than 50%, 60%, 70%, 80%, 90%, 95%, or 99% (or greater than about 50%, about 60%, about 70%, about 80%, about 90%, about 95%, or about 99%). In some embodiments, the fraction of particles within a powder that can be above a given sphericity threshold, such as described above, can be less than 50%, 60%, 70%, 80%, 90%, 95%, or 99% (or less than about 50%, about 60%, about 70%, about 80%, about 90%, about 95%, or about 99%).

Particle size distribution and sphericity may be determined by any suitable known technique such as by SEM, optical microscopy, dynamic light scattering, laser diffraction, manual measurement of dimensions using an image analysis software, for example from about 15-30 measures per image over at least three images of the same material section or sample, and any other techniques.

Titanium nitride powder which falls within the above specifications is not currently known, and therefore, AM processes using titanium nitride are not currently known. Some embodiments herein are therefore directed to systems and methods for the manufacture of metal nitride and metal carbide powders at scale, including titanium nitride powders within the specifications required for AM. However, it should be noted that the methods and systems described herein may be applied broadly to a wide spectrum of materials, particularly those that are difficult to spheroidize. With particular reference to titanium nitride, existing production of titanium nitride comprises titanium nitride thin coating on substrates using CVD. However, some embodiments herein are directed to synthesizing, for example, micron sized spherical titanium nitride powder using plasma processing. In some embodiments, the main alloying element is nitrogen. With respect to the composition of the titanium nitride powder, at different nitrogen concentrations, different nitride phases are formed, including TiN, Ti₂N, and TiN₂. These phases have different physical properties. For example, TiN is a very hard phase with high wear resistance and Ti₂N may be a relatively softer phase. Thus, based on the application and the required functional properties, different compositions and different microstructures will be desired. The embodiments herein may be directed to synthesis of titanium nitride of any desired phase, wherein the phase can be controlled by controlling the stoichiometry of a reactive plasma gas.

In some embodiments, a method for manufacturing a spheroidized metal-containing powder (e.g., metal nitride powder) may comprise using a metal powder (e.g., Ti powder) as a precursor or feedstock, and a reactive plasma gas (e.g., N₂) as a reactive gas species to synthesize the spheroidized metal-containing powder. For example, in some embodiments, a method for manufacturing a spheroidized metal nitride or carbide powder involves using commercially pure metal powder, such as commercially pure titanium powder (cpTi), as a feedstock and nitrogen or carbon-containing gas as a reactive plasma gas to synthesize metal nitride or metal carbide powder respectively. In some embodiments, the feedstock may instead comprise a liquid metal. In some embodiments, the metal powder feedstock may be preprocessed before introduction to the plasma. In some embodiments, the feedstock may be generally spherical, or generally non-spherical powder. Although the feedstock herein is generally described with respect to titanium powder, the feedstock may also comprise other metal powders, such as B, Al, or Si to form, for example, boron nitride, aluminum nitride, silicon nitride, respectively.

In some embodiments, the metal in a metal powder feedstock may react with the reactive gas species to form the spheroidized metal-containing powder within the plasma. For example, titanium has a great affinity towards interstitials such as nitrogen, hydrogen, carbon, and oxygen. These species, when present in plasma gas, are in an ionized state and are considered more “reactive”. By purposefully choosing the reactive plasma gas, which may comprise nitrogen and varying amounts of other gases such as hydrogen, argon, helium, xenon, krypton, or other “non-reactive” gases, and passing the cpTi powder through the reactive plasma gas substantially instantaneously, the reactive plasma gas may react with Ti to form spheroidized powder, such as titanium nitride powder. In some embodiments, by controlling the amount of reactive gas (e.g., N₂) in the plasma and the residence time of the metal powder particles in the plasma, it may be possible to control the stoichiometry (e.g., % of N in the compound) of metal-containing spheroidized powder produced. In conventional methods of processing titanium feedstock using plasma processing, nitrogen-containing plasma gases are generally not used. This is due to the very high affinity of Ti towards N, which was thought to form a nitride surface layer on the titanium particle. However, using the embodiments herein, it has unexpectedly been found that nitrogen-containing plasma gas may react with titanium feedstock through the complete mass of the titanium particle, leading to the unexpected result of spheroidized titanium nitride powder. Thus, the embodiments herein differ from conventional methods involving the plasma processing of titanium and similar feedstocks.

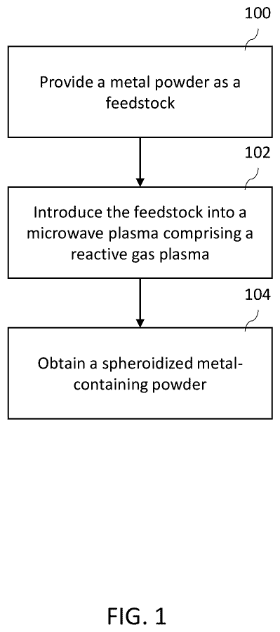

FIG. 1 illustrates an example flowchart of a process for producing a spheroidized metal-containing powder according to some embodiments described herein. In some embodiments, a method for manufacturing a spheroidized metal-containing powder may comprise providing a metal powder as a feedstock at 100. For example, the metal powder may comprise titanium powder such as, for example, commercially pure titanium (cpTi) powder, gas atomized titanium powder, hydride-dehydride (HDH) titanium powder, or titanium hydride powder. In some embodiments, the method may further comprise introducing the feedstock into a microwave plasma to form the spheroidized metal-containing powder at 102. In some embodiments, the microwave plasma may be generated by subjecting a reactive plasma gas, for example, nitrogen-containing (e.g., N₂) or carbon-containing (e.g., hydrocarbons) gas, to microwaves produced by a microwave power source. In some embodiments, the reactive plasma gas may also comprise one or more of hydrogen, helium, neon, argon, krypton, or xenon. In some embodiments, a spheroidized metal-containing powder may be formed at 104 by a chemical reaction between the feedstock and the reactive plasma gas. In some embodiments, the spheroidized metal-containing powder comprises a particle-size distribution between 15-106 microns. In some embodiments, the spheroidized metal-containing powder comprises spheroidized titanium nitride powder. In some embodiments, the spheroidized titanium nitride powder comprises one or more phases of titanium nitride, such as TiN, Ti₂N, or TiN₂.

Some embodiments of the disclosed process can include feeding the powder feedstock using a powder feeder into a microwave generated reactive plasma, wherein the power density, gas flows and residence time of the powder feedstock are controlled. The desired process parameters such as power density, flow rates and residence time of the powder in the reactive plasma can depend on the physical characteristics of the feedstock metal, such as the melting point and thermal conductivity.

Some embodiments herein relate to a process of spheroidization of metals or metal alloys using a microwave generated plasma. In some embodiments, the powder feedstock is entrained in an inert and/or reducing gas environment and injected into the microwave plasma environment. Upon injection into a hot plasma, which may comprise a plasma plume or exhaust of a plasma torch, the feedstock is spheroidized and released into a chamber filled with an inert gas and directed into hermetically sealed drums where is it stored. In some embodiments, injection of feedstock into a plasma comprises injection of the feedstock into the plasma plume or plasma exhaust. This process can be carried out at atmospheric pressure, in a partial vacuum, or at a slightly higher pressure than atmospheric pressure. In alternative embodiments, the process can be carried out in a low, medium, or high vacuum environment. The process can run continuously or in a batch process, and the collector vessels may be replaced as they fill up with spheroidized metal or metal alloy particles. The rate of cooling of the spheroidized metal and metal alloys can be controlled to strategically influence the microstructure of the spheroidized powder. By controlling the process parameters such as cooling gas flow rate, residence time, cooling gas composition etc., a microstructure of the metal and metal alloys can be controlled. The precise cooling rates required to form these structures is largely a function of the type and quantity of the alloying elements within the material.

In some embodiments, within the plasma, plasma plume, or exhaust of the plasma torch, the melted metals are inherently spheroidized due to liquid surface tension. As the microwave generated plasma exhibits a substantially uniform temperature profile, more than 90% spheroidization of particles could be achieved (e.g., 91%, 93%, 95%, 97%, 99%, 100%). After exiting the plasma, the particles are cooled before entering collection bins. When the collection bins fill, they can be removed and replaced with an empty bin as needed without stopping the process.

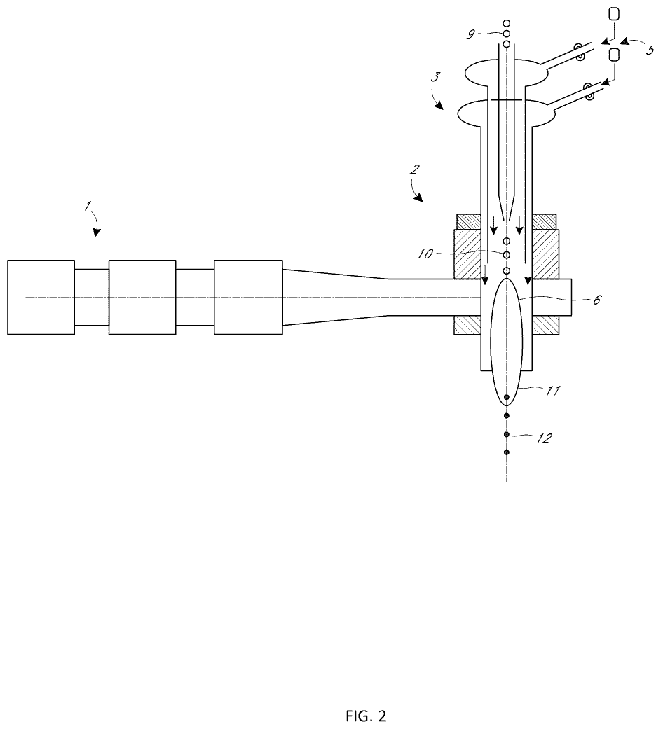

FIG. 2 illustrates an exemplary microwave plasma torch that can be used in the production of spheroidal metal or metal alloy powders, according to some embodiments herein. As discussed above, metal feed materials 9, 10 can be introduced into a microwave plasma torch 2, which sustains a microwave generated plasma 11. In some embodiments, a microwave plasma torch may include a side feeding hopper rather than the top feeding hopper 3 shown in the embodiment of FIG. 2, thus allowing for downstream feeding. Thus, in this implementation the feedstock is injected after the microwave plasma torch applicator for processing in the “plume” or “exhaust” 6 of the microwave plasma torch. Thus, the plasma of the microwave plasma torch is engaged at the exit end of the plasma torch to allow downstream feeding of the feedstock, as opposed to the top-feeding (or upstream feeding) discussed with respect to FIG. 2. Other feeding configurations may include one or several individual feeding nozzles surrounding the plasma plume. The feedstock powder can enter the plasma from any direction and can be fed in 360° around the plasma. The feedstock powder can enter the plasma at a specific position along the length of the plasma plume where a specific temperature has been measured and a residence time estimated for sufficient melting of the particles. The melted particles exit the plasma into a sealed chamber where they are quenched then collected.

In some embodiments, an entrainment gas flow, and a sheath flow (downward arrows) may be injected through inlets 5 to create flow conditions within the plasma torch prior to ignition of the plasma 11 via microwave radiation source 1. In some embodiments, the entrainment flow and sheath flow are both axis-symmetric and laminar, while in other embodiments the gas flows are swirling. The feed materials 9 may be introduced axially or otherwise into the microwave plasma torch, where they are entrained by a gas flow that directs the materials toward the plasma. Within the microwave generated plasma, the feed materials are melted in order to spheroidize the materials and chemical reactions between the feedstock and reactive plasma gases may occur. Inlets 5 can be used to introduce process gases to entrain and accelerate particles 9, 10 along axis 12 towards plasma 11. First, particles 9 are accelerated by entrainment using a core laminar gas flow (upper set of arrows) created through an annular gap within the plasma torch. A second laminar flow (lower set of arrows) can be created through a second annular gap to provide laminar sheathing for the inside wall of dielectric torch 2 to protect it from melting due to heat radiation from plasma 11. In some embodiments, the laminar flows direct particles 9, 10 toward the plasma 11 along a path as close as possible to axis 12, exposing them to a substantially uniform temperature within the plasma 11. In some embodiments, suitable flow conditions are present to keep particles 10 from reaching the inner wall of the plasma torch 2 where plasma attachment could take place. Particles 9, 10 are guided by the gas flows towards microwave plasma 11 were each undergoes homogeneous thermal treatment. Various parameters of the microwave generated plasma, as well as particle parameters, may be adjusted in order to achieve desired results. These parameters may include microwave power, feedstock material size, feedstock material insertion rate, gas flow rates, plasma temperature, residence time, and cooling rates. In some embodiments, the gas flows are laminar; however, in alternative embodiments, swirl flows or turbulent flows may be used to direct the feed materials toward the plasma.

### Examples

Titanium nitride powder was synthesized from cpTi powder within a microwave plasma using nitrogen gas as a reactive plasma gas. The titanium nitride powder exhibited a 45-106 micron particle-size distribution (PSD) and was synthesized using a microwave plasma generated using a nitrogen gas (N₂) as a plasma gas. The cpTi, which was made by the HDH method, was treated in a reactive plasma comprising a mixture of nitrogen (N₂) and hydrogen (H₂). A small amount of hydrogen (˜10%) was introduced in the reactive nitrogen gas to prevent oxidation of the cpTi powder during the plasma treatment. The plasma treatment transformed the irregular shaped HDH cpTi powder into a spherical titanium nitride powder. During spheroidization, due to the high temperatures and the contact between ionized nitrogen species in the plasma with fully melted, surface melted or partially melted cpTi particles, a reaction between Ti and N was initiated, resulting in titanium nitride, TiₓN_{y}. Example reactions are shown below:

$$2 Ti ( s ) + {N}_{2} ( g ) \to 2 TiN ( s )$$

$$4 Ti ( s ) + {N}_{2} ( g ) \to 2 {Ti}_{2} N ( s )$$

The titanium nitride synthesized had the following elemental composition: nitrogen at 12% by weight, oxygen at 0.34% by weight, iron at 0.034% by weight, carbon at 0.0068% by weight, and titanium at 85.9% by weight. The titanium nitride synthesized had a particle size distribution wherein D₁₀ was 50.35 microns, D₅₀ was 68.5 microns, and D₉₀ was 97.73 microns. The titanium nitride synthesized had the following physical properties: Hall Flow of 27 s/50 g, apparent density (AD) of 2.54 g/cubic cm, true density of 4.9 g/cubic cm, and tapped density (TD) of 2.91 g/cubic cm.

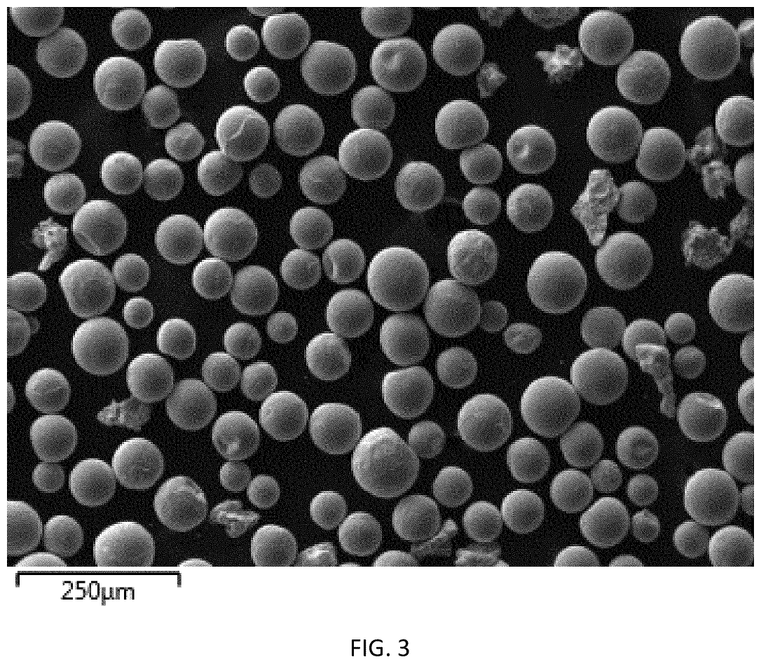

FIG. 3 illustrates an example morphology of titanium nitride powder synthesized according to some embodiments described herein. As shown, the particles of the titanium nitride powder are substantially spherical, such that use of the powder in an AM process is possible.

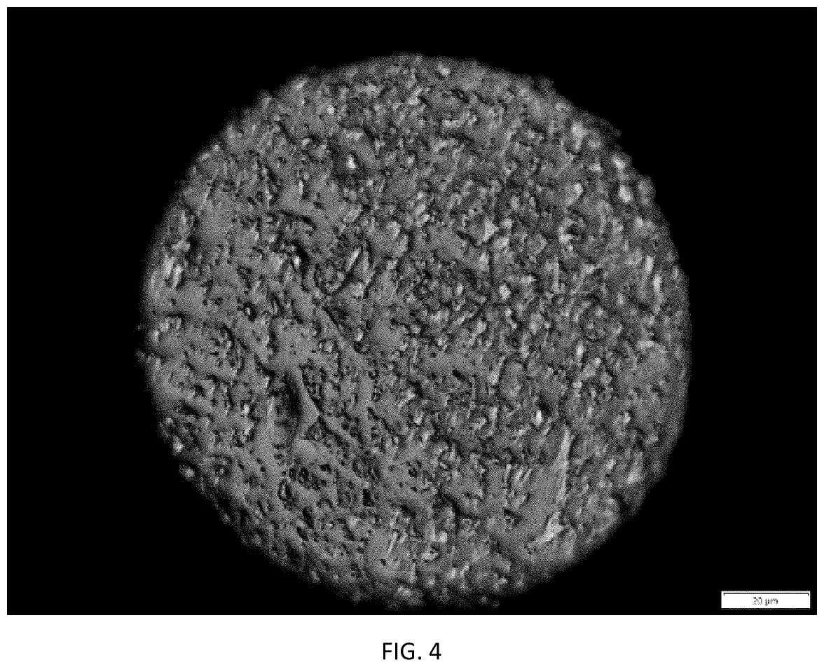

FIG. 4 illustrates an example microstructure of titanium nitride powder synthesized according to some embodiments described herein. In some embodiments, the microstructure of the titanium nitride powder may comprise one or more separate phases. For example, in some embodiments, phases may include α-Ti, TiN, Ti₂N, or TiN₂. In some embodiments, a titanium nitride shell will be formed with cpTi core. Whether a titanium nitride shell is formed or the powder comprises titanium nitride throughout the particles depends on the processing conditions within the plasma torch. In the illustrated microstructure of FIG. 4, the microstructure represents a Ti matrix with TiN and Ti₂N phases dispersed in the matrix.

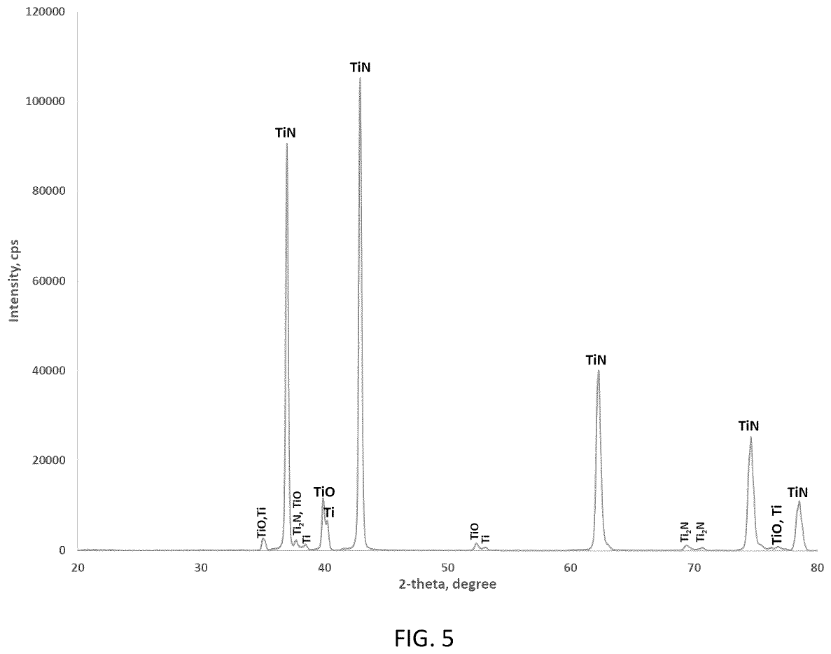

FIG. 5 illustrates an example X-ray powder diffraction of a titanium nitride powder synthesized according to some embodiments described herein. As illustrated, the powder is generally formed of TiN with TiO, Ti, and Ti₂N.

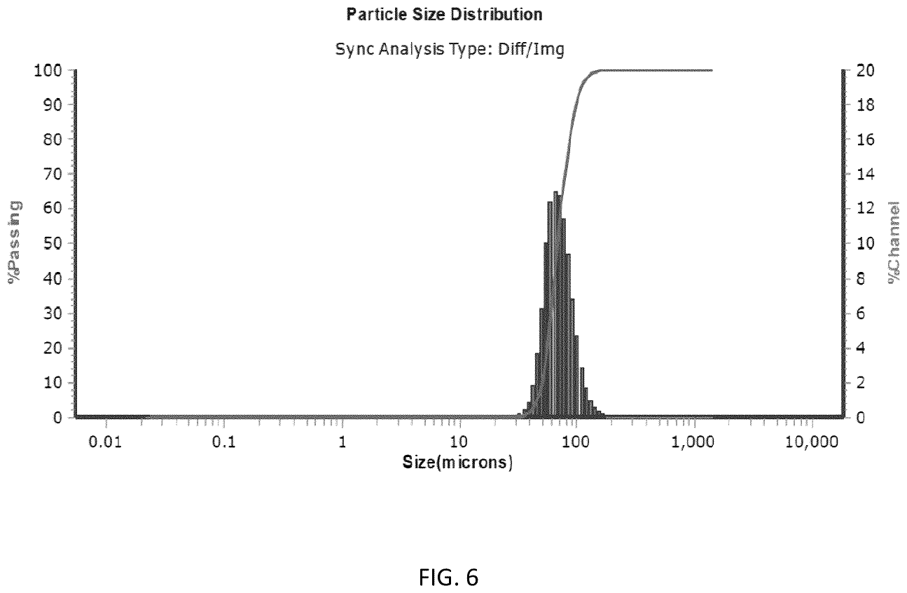

FIG. 6 illustrates an example particle size distribution of a titanium nitride powder synthesized according to some embodiments described herein. In some embodiments, a titanium nitride powder may comprise a particle size distribution between about 15 microns and about 150 microns.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub combination. Moreover, although features may be described above as acting in certain combinations and even initially claimed as such, one or more features from a claimed combination may in some cases be excised from the combination, and the claimed combination may be directed to a sub combination or variation of a sub combination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

1. (canceled)

2. A spheroidized titanium nitride powder comprising:
a plurality of titanium nitride particles exhibiting a substantially spherical shape,
the plurality of titanium nitride particles comprising a particle-size distribution between 15-106 microns and
the plurality of titanium nitride particles comprising at least one of the following phases: α-Ti, TiN, Ti₂N, or TiN₂.

3. The spheroidized titanium nitride powder of claim 2, wherein the spheroidized titanium nitride powder is synthesized by microwave plasma processing of a titanium feedstock.

4. The spheroidized titanium nitride powder of claim 3, wherein the plurality of particles comprise a microstructure formed by reacting the titanium feedstock with a nitrogen-containing plasma gas.

5. The spheroidized titanium nitride powder of claim 2, wherein the plurality of particles have a mean sphericity greater than 0.75 or 0.91.

6. The spheroidized titanium nitride powder of claim 2, wherein the plurality of particles have a median sphericity greater than 0.75 or 0.91.

7. The spheroidized titanium nitride powder of claim 2, wherein the plurality of particles comprise a titanium nitride shell formed with a cpTi core.

8. The spheroidized titanium nitride powder of claim 2, wherein the plurality of particles comprise titanium nitride throughout the particles.

9. The spheroidized titanium nitride powder of claim 2, wherein the spheroidized titanium nitride powder is manufactured by a method comprising:
providing a feedstock to a microwave plasma torch, the feedstock comprising titanium powder;
introducing the feedstock into a microwave plasma generated by the microwave plasma torch, the microwave plasma generated by subjecting a reactive plasma gas to microwaves from a microwave power source, the reactive plasma gas comprising at least nitrogen-containing gas; and
forming the spheroidized titanium nitride powder, the spheroidized titanium nitride powder formed by at least partially melting the feedstock and initiating a chemical reaction between the feedstock and the reactive plasma gas within the microwave plasma torch, and the spheroidized titanium nitride powder comprising one or more particles, the one or more particles comprising titanium nitride throughout a complete mass of the one or more particles,
wherein the one or more particles comprise a pre-determined concentration of nitrogen by controlling an amount of the nitrogen-containing gas and a residence time of the feedstock in the reactive plasma gas.

10. The spheroidized titanium nitride powder of claim 9, wherein the method further comprises selecting a desired porosity, composition, or microstructure of the spheroidized titanium nitride powder, and wherein the spheroidized titanium nitride powder comprises the desired porosity, composition, or microstructure.

11. The spheroidized titanium nitride powder of claim 9, wherein the titanium powder comprises commercially pure titanium (cpTi) powder.

12. The spheroidized titanium nitride powder of claim 9, wherein the titanium powder comprises gas atomized titanium powder, hydride-dehydride (HDH) titanium powder, or hydrided titanium powder.

13. The spheroidized titanium nitride powder of claim 9, wherein the nitrogen-containing gas comprises one or more of hydrogen, helium, neon, argon, krypton, or xenon.

14. The spheroidized titanium nitride powder of claim 9, wherein the reactive plasma gas comprises nitrogen gas (N₂).

15. The spheroidized titanium nitride powder of claim 9, wherein the chemical reaction comprises:
2Ti+N₂→2TiN; or
4Ti+N₂→2Ti₂N.

16. The spheroidized titanium nitride powder of claim 2, wherein the spheroidized titanium nitride powder is manufactured by a method comprising:
providing a metal powder as a feedstock to a microwave plasma torch;
introducing the feedstock into a microwave plasma generated by the microwave plasma torch, the microwave plasma generated by subjecting a nitrogen-containing gas to microwaves from a microwave power source; and
forming the spheroidized titanium nitride powder, the spheroidized titanium nitride powder formed by at least partially melting the feedstock and initiating a chemical reaction between the feedstock and the nitrogen-containing gas within the microwave plasma torch, and the spheroidized titanium nitride powder comprising one or more particles, the one or more particles comprising titanium nitride throughout a complete mass of the one or more particles,
wherein the one or more particles comprise a pre-determined concentration of nitrogen by controlling an amount of the nitrogen-containing gas and a residence time of the feedstock in the reactive plasma gas.

17. The spheroidized titanium nitride powder of claim 16, wherein the method further comprises selecting a desired porosity, composition, or microstructure of the spheroidized titanium nitride powder, and wherein the spheroidized titanium nitride powder comprises the desired porosity, composition, or microstructure.

18. The spheroidized titanium nitride powder of claim 16, wherein the metal powder comprises commercially pure titanium (cpTi) powder.

19. The spheroidized titanium nitride powder of claim 16, wherein the metal powder comprises gas atomized titanium powder, hydride-dehydride (HDH) titanium powder, or hydrided titanium powder.

20. The spheroidized titanium nitride powder of claim 16, wherein the nitrogen-containing gas comprises one or more of hydrogen, helium, neon, argon, krypton, or xenon.

21. The spheroidized titanium nitride powder of claim 16, wherein the reactive plasma gas comprises nitrogen gas (N₂).
